(19) United States
(12) Patent Application Publication
(10) Pub. No.: US 2016/0160754 A1
(43) Pub. Date: Jun. 9, 2016

(54) Controller for Free Piston Generator

(71) Applicant: KABUSHIKI KAISHA TOYOTA CHUO KENKYUSHO, Nagakute-shi (JP)

(72) Inventors: Kazunari MORIYA, Nagakute-shi (JP); Shigeaki GOTO, Nagakute-shi (JP); Hidemasa KOSAKA, Nagakute-shi (JP); Tomoyuki AKITA, Nagakute-shi (JP); Yoshihiro HOTTA, Nagakute-shi (JP); Kiyomi NAKAKITA, Nagakute-shi (JP)

(73) Assignee: KABUSHIKI KAISHA TOYOTA CHUO KENKYUSHO, Nagakute-shi (JP)

(21) Appl. No.: 14/954,411

(22) Filed: Nov. 30, 2015

(30) Foreign Application Priority Data
Dec. 3, 2014 (JP) 2014-244949
Nov. 25, 2015 (JP) 2015-229277

(51) Int. Cl. F02B 71/06

(52) U.S. Cl. CPC F02B 71/06

(57) ABSTRACT

A controller for a free piston generator that is capable of more accurately controlling the behavior of a piston than conventional controllers is provided. During power generation of a free piston generator 10, a controller 18 controls the amount of power generation to cause the velocity of a piston 14 to reach a first velocity command value (for an expansion stroke) and a second velocity command value (for a compression stroke) by electric braking. During motoring, the controller 18 controls the amount of power supply to cause the velocity of the piston 14 to reach the first and second velocity command values. The controller 18 sets the first and second velocity command values by setting first and second velocity command values for a certain round-trip period based on a top dead center position and a bottom dead center position of the piston 14 for the previous round-trip period.

### PRIORITY INFORMATION

This application claims priority to Japanese Patent Applications Nos. 2014-244949 filed on Dec. 3, 2014 and 2015-229277 filed on Nov. 25, 2015, which is incorporated herein by reference in its entirety.

### BACKGROUND

1. Technical Field

The present invention relates to a controller for a free piston generator that generates power by causing a piston with a magnet embedded therein to reciprocate in a cylinder provided with a coil.

2. Related Art

Free piston generators that generate power by causing a piston to reciprocate in a cylinder have been heretofore known in the art. The piston can reciprocate in the cylinder without any mechanical connection.

A combustion chamber is provided at one end of the cylinder in the direction in which the piston reciprocates (the longitudinal direction of the cylinder), and a gas spring chamber is provided at another end of the cylinder. Combustion of a gas mixture of fuel and air in the combustion chamber causes the piston to move from the combustion chamber toward the gas spring chamber by means of combustion pressure. As the piston moves, the volume of the gas spring chamber is compressed. A repulsive force responding to the compression is then produced and causes the piston to move back toward the combustion chamber.

Permanent magnets are provided on the outer circumferential surface of the piston, and a coil is provided on the inner circumferential surface of the cylinder. As the piston reciprocates, the permanent magnets and the coil move relative to each other. An induced electromotive force produced by this relative movement generates electricity.

Florian Kock, et al. propose a method for controlling the behavior of a piston in a free piston generator in “The Free Piston Linear Generator—Development of an Innovative, Compact, Highly Efficient Range-Extender Module”, SAE International, SAE Transactions, Apr. 8, 2013, 2013-01-1727. This paper proposes an equation for calculating an amount of generated energy by subtracting kinetic energy of the piston from a sum of energy applied to the piston by combustion, energy accumulated in air by compression of the gas spring, and frictional energy acting between the cylinder and the piston.

In energy balance-based control methods, which are significantly affected by disturbances, it is not easy to accurately determine parameters. For example, because combustion fluctuations occur in the combustion chamber, it is difficult to accurately determine energy applied to the piston by combustion, one of the above-described parameters. The difficulty in determining parameters will lower the accuracy of piston control. Therefore, an object of the present invention is to provide a controller for a free piston generator that is capable of more accurately controlling the behavior of a piston than conventional controllers.

### SUMMARY

According to one aspect of the present invention, there is provided a controller for a free piston generator that generates power by causing a piston with a magnet embedded therein to reciprocate in a cylinder provided with a coil. The cylinder has a combustion chamber therein. The controller is configured to set a first velocity command value for an expansion stroke in which the piston is moved away from the combustion chamber and a second velocity command value for a compression stroke in which the piston is moved toward the combustion chamber; and control an amount of power generation to cause a velocity of the piston to reach the first and second velocity command values by electric braking during power generation, or control an amount of power supply to cause the velocity of the piston to reach the first and second velocity command values by exciting the coil during motoring, wherein setting the first and second velocity command values comprises setting first and second velocity command values for a certain round-trip period based on a top dead center position, at which the piston is located closest to the combustion chamber, and a bottom dead center position, at which the piston is located most far away from the combustion chamber, for the previous round-trip period.

In preferred embodiments of this invention, the cylinder further has a gas spring chamber therein, and the piston reciprocates between the combustion chamber and the gas spring chamber.

In preferred embodiments of this invention, the controller is further configured to determine an amplitude of a velocity command wave having the first velocity command value and the second velocity command value as peak values and an amount of offset of the velocity command wave from a velocity of zero for a certain round-trip period based on a difference between an actual top dead center position and a top dead center target position and a difference between an actual bottom dead center position and a bottom dead center target position for the previous round-trip period. In preferred embodiments of this invention, the controller is further configured to reduce a difference between an absolute value of the first velocity command value and an absolute value of the second velocity command value by changing the bottom dead center target position.

In preferred embodiments of this invention, the controller is further configured to, when a total amount of power generation during control based on the first velocity command value is greater than a total amount of power generation during control based on the second velocity command value, change a bottom dead center target position of the piston to move away from a stroke center position of the piston; and when a total amount of power generation during control based on the second velocity command value is greater than a total amount of power generation during control based on the first velocity command value, change the bottom dead center target position of the piston to move toward the stroke center position of the piston. In preferred embodiments of this invention, the controller is further configured to increase a gas pressure in the gas spring chamber in accordance with an increase in combustion pressure in the combustion chamber. In preferred embodiments of this invention, the controller is further configured to, at a start of motoring, control excitation current supplied to the coil to urge the piston toward a side opposite a stop position of the piston with respect to a stroke center position. In preferred embodiments of this invention, the controller is further configured to control power generation and supply timing to suspend power generation and supply while the piston is being located at the top dead center position or the bottom dead center position. In preferred embodiments of this invention, the controller is further configured to, during the motoring, set a region extending from a half value representing a midpoint between a top dead center target position and a point of origin to a half value representing a midpoint between a bottom dead center target position and the point of origin as an excitation region for the coil. According to another aspect of the present invention, there is provided a controller for a free piston generator that generates power by causing a piston with a magnet embedded therein to reciprocate between a combustion chamber and a gas spring chamber in a cylinder provided with a coil. The controller is configured to set a first velocity command value for an expansion stroke in which the piston is moved toward the gas spring chamber and a second velocity command value for a compression stroke in which the piston is moved toward the combustion chamber; control an amount of power generation to cause a velocity of the piston to reach the first and second velocity command values by electric braking during power generation, or control an amount of power supply to cause the velocity of the piston to reach the first and second velocity command values by exciting the coil during motoring; and control power generation and supply timing to suspend power generation and supply while the piston is being located at a top dead center position, at which the piston is located closest to the combustion chamber, or at a bottom dead center position, at which the piston is located closest to the gas spring chamber.

By employing the present invention, it is possible to provide a controller for a free piston generator that is capable of more accurately controlling the behavior of a piston than conventional controllers.

### BRIEF DESCRIPTION OF THE DRAWINGS

FIG. 1 schematically illustrates a free piston power generation system according to an embodiment of the present invention.

FIG. 2 is an enlarged cross-sectional view of a portion near a row of slits.

FIG. 3 illustrates velocity control according to an embodiment of the present invention.

FIG. 4 illustrates an example of a method for actuating a piston according to an embodiment of the present invention.

FIG. 5 illustrates a method for setting velocity command values.

FIG. 6 illustrates a method for changing the velocity command values.

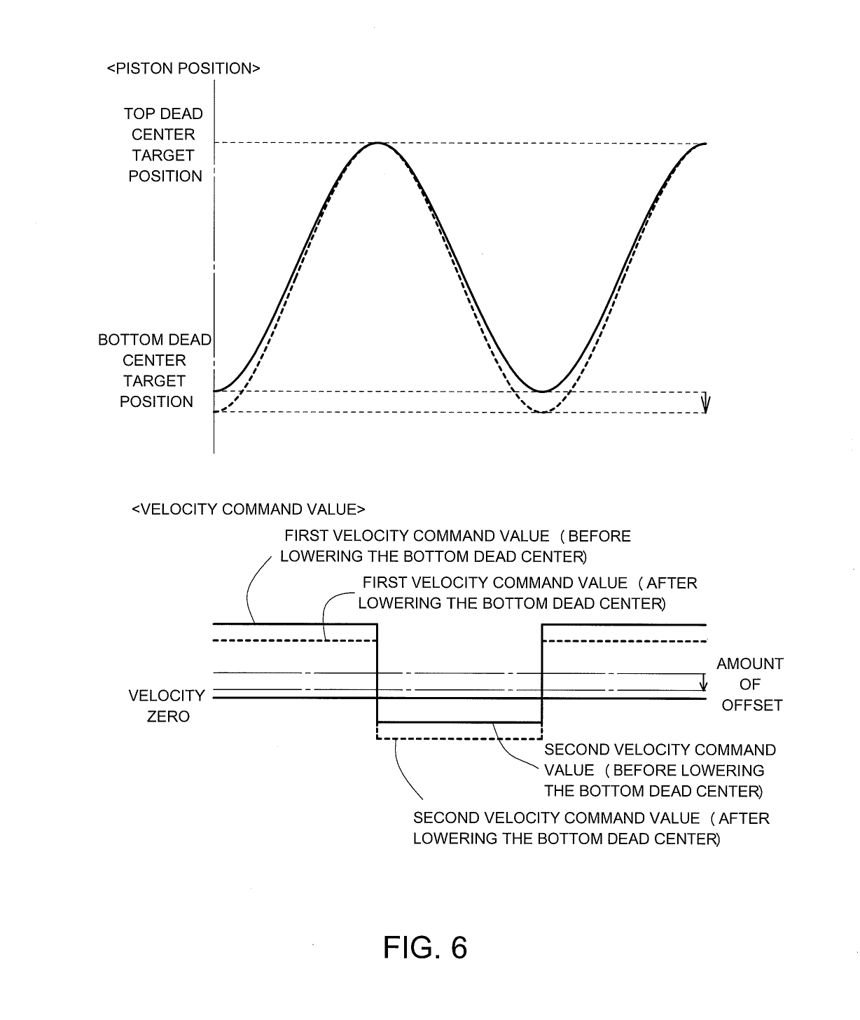

### DETAILED DESCRIPTION

### Overall Structure

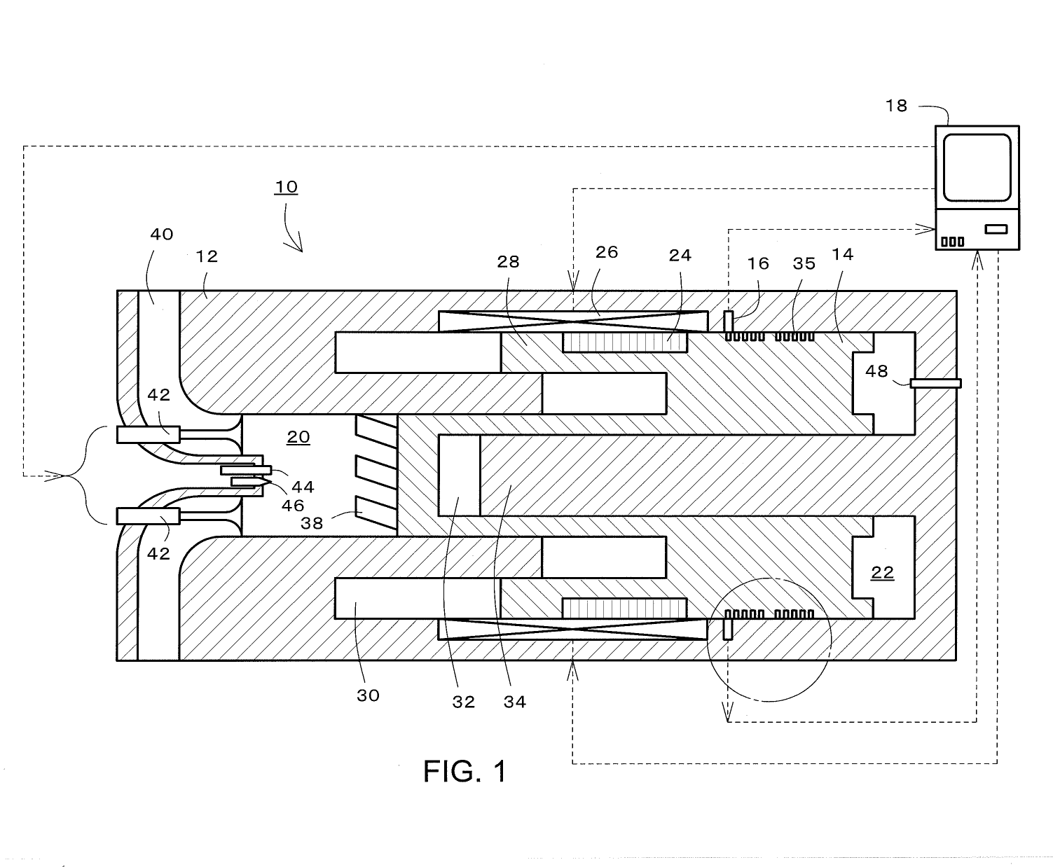

FIG. 1 schematically illustrates a free piston power generation system according to an embodiment of the present invention. The free piston power generation system includes a free piston generator 10, and a controller 18 for the free piston generator 10. The free piston generator 10 includes a cylinder 12, a piston 14, and detectors 16.

A combustion chamber 20 is provided at one end of the cylinder 12 in the longitudinal direction of the cylinder 12, and a gas spring chamber 22 is provided at another end of the cylinder 12. The piston 14 is disposed in the cylinder 12 and reciprocates between the combustion chamber 20 and the gas spring chamber 22 by means of combustion pressure produced in the combustion chamber 20 and repulsive force responding to the compression of the gas spring chamber 22.

Permanent magnets 24 are provided on the outer circumferential surface of the piston 14, and a coil 26 is wound in the circumferential direction on the inner circumferential surface of the cylinder 12. As the piston 14 reciprocates, the permanent magnets 24 and the coil 26 move relative to each other. An induced electromotive force produced by this relative movement generates electricity.

To actuate the free piston generator 10, or, more specifically, to cause the piston 14 that is being stopped to start reciprocating, the free piston generator 10 is used as an electric motor. The operation of using the free piston generator 10 as an electric motor includes initialization and motoring in an embodiment of the present invention. The initialization is an operation of searching for an absolute value by moving the piston 14 when an absolute position of the piston 14 is unknown. The motoring refers to moving the piston 14 by passing an excitation current through the coil 26 after the initialization, and this drive mode of the piston 14 is in a relationship opposite to firing in which the piston 14 is moved by means of combustion pressure (explosion energy). During power generation (or during firing), the controller 18 controls the behavior of the piston 14 urged by, for example, combustion pressure or repulsive force of the gas spring chamber 22, by controlling a velocity of the piston 14 by electric braking. During startup (and during motoring), the controller 18 controls the behavior of the piston 14 by controlling the velocity by adjusting the excitation current passed through the coil 26. The electric braking includes both dynamic braking in which generated power is consumed by a resistor, and regenerative braking in which generated power is distributed to another electrical device. In some embodiments of the present invention, at least one of dynamic braking and regenerative braking is performed.

### Details of Components

The piston 14 is housed in the cylinder 12 and reciprocates in the cylinder 12. A small clearance is provided between the piston 14 and the cylinder 12, allowing the piston 14 to move in the cylinder 12 while suppressing gas flow between the combustion chamber 20 and the gas spring chamber 22. In the example illustrated in FIG. 1, the piston 14 has a smaller diameter on the side closer to the combustion chamber 20 and has a larger diameter on the side closer to the gas spring chamber 22. With such a structure, as the piston 14 has a larger pressure-receiving area on the side closer to the gas spring chamber 22 than a pressure-receiving area on the side closer to the combustion chamber 20, the piston 14 can be pushed back toward the combustion chamber 20 even if the pressure of the gas spring chamber 22 is rather small.

The piston 14 has an annular portion 28 protruding toward the combustion chamber 20 on an outermost circumferential portion of the larger diameter portion (on the gas spring chamber side). The annular portion 28 has a shape to be received in a guide ring groove 30 that is provided in the cylinder 12 on the side closer to the combustion chamber 20. By causing the piston 14 to reciprocate with the annular portion 28 being received in the guide ring groove 30, the reciprocating motion (stroke) is stabilized. Additionally, a non-through hole 32 is drilled in the axial direction on the back side of the smaller diameter portion of the piston 14, or, in other words, on the side closer to the gas spring chamber 22, as an additional means for stabilizing the reciprocating motion of the piston 14. A guide shaft 34 extending from the gas spring chamber 22 of the cylinder 12 is received in the non-through hole 32.

The permanent magnets 24 are provided on the outer circumferential surface of the larger diameter portion of the piston 14 including the annular portion 28, or, in other words, on the outermost circumferential surface of the piston 14. In preferred embodiments, the permanent magnets 24 are disposed to oppose the coil 26 throughout the stroke of the piston 14.

As the permanent magnets 24 are provided on the outer circumferential surface of the larger diameter portion that is spaced relatively far away from the combustion chamber 20, heat produced from the combustion chamber 20 does not easily transfer to the permanent magnets 24, and therefore, demagnetization that would be caused if the permanent magnets 24 were heated to high temperatures can be prevented.

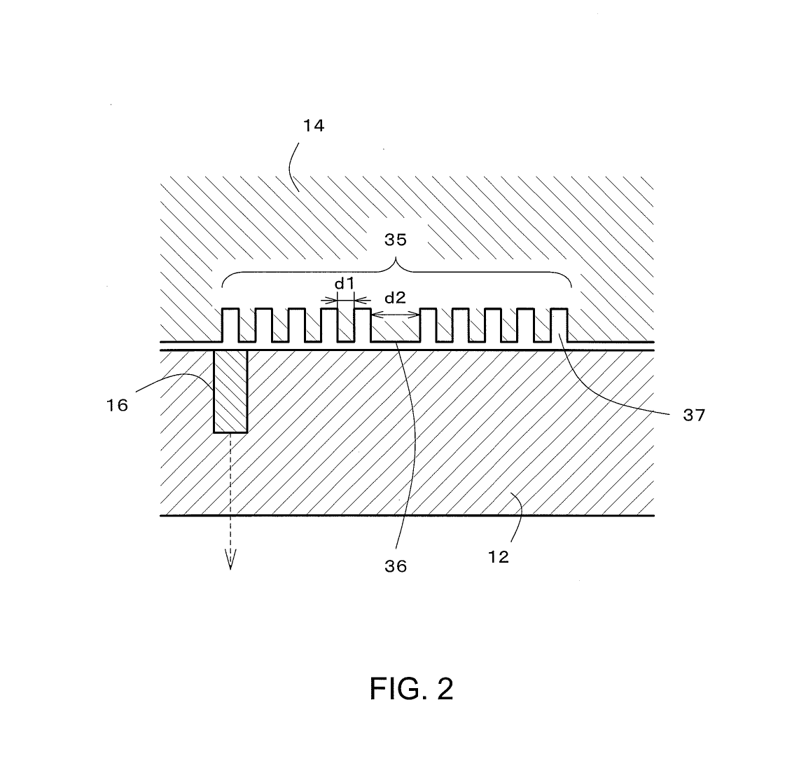

In addition to the permanent magnets 24, rows of slits 35 are cut into the outer circumferential surface of the larger diameter portion of the piston 14 including the annular portion 28. Although, in the example illustrated in FIG. 1, rows of slits 35 are cut into upper and lower portions of the piston 14 as viewed in FIG. 1, rows of slits 35 may be further cut into both side surfaces. In other words, rows of slits 35 may be cut into the outer circumferential surface of the piston 14 at intervals of 90 degrees around the circumference. The rows of slits 35 may be formed with the phase being shifted. For example, rows of slits 35 may be cut into surfaces at intervals that are a quarter of an interval between adjacent slits 37 and 37 (see FIG. 2). With such a structure, the position of the piston 14 can be accurately detected. FIG. 2 provides an enlarged view of a row of slits 35, or, more specifically, an enlarged view of a portion marked by an alternate long and short dashed line circle in FIG. 1. The row of slits 35 are formed by cutting a plurality of slits 37 in the axial direction of the piston 14. In the illustrated embodiment, a characteristic portion 36 having a pitch (interval) between adjacent slits 37 and 37 that is different from a pitch of other portions is provided. For example, in FIG. 2, a characteristic portion 36 having a pitch d2 that is different from a pitch d1 between slits 37 and 37 is provided in a center portion of the row of slits 35. Although, in FIG. 1, characteristic portions 36 are provided in upper and lower rows of slits 35 as viewed in FIG. 1, a characteristic portion 36 may be provided in one of a plurality of rows of slits 35 formed around the circumference.

A row of slits 35 may be formed to oppose a detector 16 throughout the stroke of the piston 14. For example, when the piston 14 is located at a top dead center (the position closest to the combustion chamber 20), the rightmost slit 37 in the row of slits 35 as viewed in FIG. 1 opposes the detector 16, and when the piston 14 is located at a bottom dead center (the position closest to the gas spring chamber 22), the leftmost slit 37 in the row of slits 35 as viewed in FIG. 1 opposes the detector 16. Additionally, in preferred embodiments, a characteristic portion 36 is formed in the piston 14 to oppose the detector 16 when the piston 14 is located at the center of the stroke, or, in other words, at the center of the length of the cylinder.

Referring again to FIG. 1, the cylinder 12 is a hollow, substantially cylindrical member. The length of the hollow portion in the longitudinal direction, or, in other words, the length of the cylinder, is the length of the stroke, and its center position is the center (point of origin) of the stroke. Ends of the length of the stroke are ends of the stroke. To conform to the shape of the piston 14, the hollow shape of the cylinder has a smaller diameter on the side closer to the combustion chamber 20 and has a larger diameter on the side closer to the gas spring chamber 22.

The combustion chamber 20 is formed at one end in the direction in which the piston 14 reciprocates, or, in other words, the direction of the length of the cylinder, and the gas spring chamber 22 is formed at another end. The combustion chamber 20 has scavenging ports 38, exhaust ports 40, exhaust valves 42, an injector 44, and an igniter 46.

The scavenging ports 38 introduce fresh air into the combustion chamber 20. To introduce fresh air, a scavenging pump (not shown) may be driven so that fresh air is externally introduced through the scavenging ports 38. The scavenging ports 38 may have openings on, for example, an inner wall surface of the cylinder 12, and may be formed at a position at which the scavenging ports 38 are shut by the piston 14 when the piston 14 is located at the top dead center and are open when the piston 14 is located at the bottom dead center.

The exhaust ports 40 vent exhaust gas produced after a gas mixture of fresh air and fuel is burnt in the combustion chamber, to the outside. In some embodiments, the combustion chamber 20 has no exhaust port 40, and the scavenging ports 38 may serve as both scavenging and exhaust ports in a loop flow system.

The injector 44 is an injection means for injecting fuel. The igniter 46 ignites a gas mixture to produce combustion pressure. In some embodiments, the combustion chamber 20 has no igniter 46, and combustion pressure may be produced using a compression ignition method.

The gas spring chamber 22 has the function of pushing back the piston 14 toward the combustion chamber 20. As the piston 14 moves from the side closer to the combustion chamber 20 toward the gas spring chamber 22, the gas spring chamber 22 is compressed. The compression produces repulsive force, and the repulsive force pushes back the piston 14 toward the combustion chamber 20. To keep the internal pressure within a certain range, the gas spring chamber 22 may have a pressure-regulating valve 48. Alternatively, instead of the pressure-regulating valve 48, a pressurization source such as a compressor may be connected to the gas spring chamber 22.

The coil 26 is provided on the inner circumferential surface of the cylinder 12. In preferred embodiments, the coil 26 is provided at a position at which the coil 26 opposes the permanent magnets 24 throughout the stroke of the piston 14. The coil 26 is connected to an external power converter (not shown) such as an inverter. Alternating-current power generated by the coil 26 is converted to direct-current power by the power converter and is supplied to a direct-current power source such as a battery. Also, during the initialization or during the motoring, direct-current power supplied from the direct-current power source is converted to alternating-current power by the power converter and is supplied to the coil 26.

The detectors 16 detect a displacement of the piston 14 by detecting passage of rows of slits 35 that oppose the detectors 16. The detectors 16 also detect the characteristic portions 36 of the rows of slits 35. In addition to the coil 26, the detectors 16 are provided on the inner circumferential surface of the larger diameter portion of the cylinder 12. As described above, in preferred embodiments, the detectors 16 are provided at positions at which the detectors 16 oppose the rows of slits 35 throughout the stroke of the piston 14.

The detectors 16 may output two values in accordance with projections and depressions of the slits 37. For example, when a detector 16 faces a bottom surface of a slit 37, the detector 16 outputs a detection signal S1H. When the detector 16 faces a projecting surface between slits 37 and 37, the detector 16 outputs a detection signal S1L.

The detector 16 may include a counter for counting the values of the detection signals S1. For example, the counter may be composed by a hardware circuit in the detector 16. The counter is configured to increment each time a value (H/L) of a detection signal S1 is increased, so that the position of the piston 14 can be calculated based on this counter value. Additionally, the counter may be configured to reset the counter value when a characteristic portion 36 in a row of slits 35 is detected. The reset operation allows detection of an absolute position of the piston 14. The counter value is transmitted to the controller 18.

The detector 16 may be composed by one of, for example, an eddy current sensor, an optical sensor, a capacitance sensor, and other non-contact sensors. It should, however, be noted that it may be difficult to maintain a good optical detection environment; for example, lubricating oil in the cylinder 12 may adhere to the inner surface of the cylinder 12 or the outer surface of the piston 14. Therefore, in preferred embodiments, an eddy current sensor or a capacitance sensor is used as the detector 16.

The controller 18 controls the behavior of the piston 14 for stable power generation in the free piston generator 10. During the initialization or during the motoring, the free piston generator 10 is caused to function as an electric motor to move the piston 14.

The controller 18 may be composed by a computer, and, for example, a CPU serving as an arithmetic circuit, a storage unit such as a memory, and a device-sensor interface are connected to each other through an internal bus. The storage unit stores a velocity control program, which will be described below, and the CPU executes this program to perform the velocity control.

The controller 18 exchanges signals with peripheral devices through the device-sensor interface. Specifically, the controller 18 receives counter values from the detectors 16 and transmits operating signals to the exhaust valves 42, the injector 44, and the igniter 46. During electric braking, the controller 18 controls the amount of power generation in the free piston generator 10. The controller 18 selects, for example, a unit to which generated power is to be supplied (an electrical device, a battery, a resistor, or the like). The controller 18 further controls the amount of excitation current supplied to the coil 26 during the motoring.

### Piston Control Based on Velocity Control

The controller 18 according to the illustrated embodiment controls the behavior of the piston 14 based on velocity control. The controller 18 determines a first velocity command value for an expansion stroke in which the piston 14 is moved toward the gas spring chamber 22, and determines a second velocity command value for a compression stroke in which the piston 14 is moved toward the combustion chamber 20.

Velocity control is performed to adjust the velocity of the piston 14 to reach a velocity command value that is determined for each of the expansion stroke and the compression stroke. During power generation (or during firing), velocity control is performed by electric braking. More specifically, the controller 18 controls the amount of power generation to cause the velocity of the piston 14 to reach the first velocity command value (for the expansion stroke) and the second velocity command value (for the compression stroke). During startup (and during motoring), velocity control is performed by excitation current control. More specifically, the controller 18 controls the amount of power supplied to the coil 26 to cause the velocity of the piston 14 to reach the first velocity command value (for the expansion stroke) and the second velocity command value (for the compression stroke).

The velocity of the piston 14 is the minimum velocity at the top dead center and at the bottom dead center, and is the maximum velocity at the stroke center position. In accordance with such behavior, dynamic braking and excitation are performed.

Because the relationship between the amount of power generation and the amount of braking of the piston 14 and the relationship between the amount of power supply (the amount of excitation current) and the amount of propulsion of the piston 14 are known, the velocity control according to the illustrated embodiment can control the behavior of the piston 14 more accurately than conventional piston control based on energy balance, which is significantly affected by disturbances.

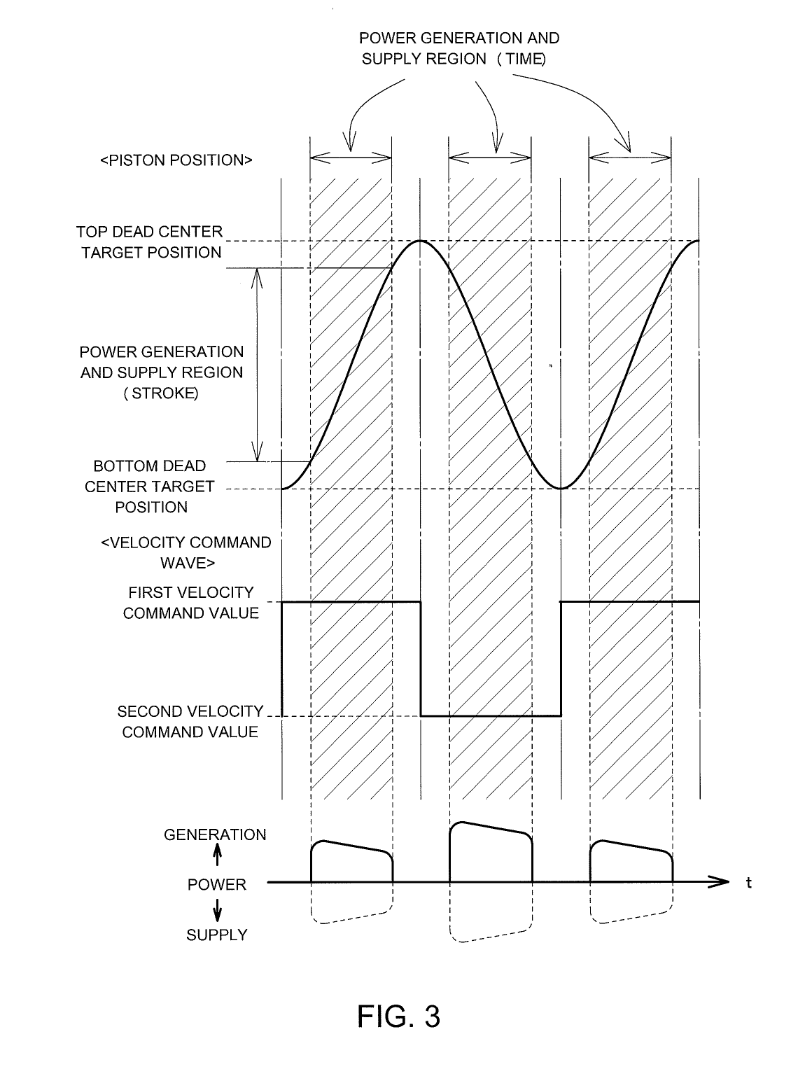

Although the above-described dynamic braking and excitation of the coil 26 may be performed throughout the stroke of the piston 14, control may be performed focusing only on regions in which velocity control efficiency is higher than in other regions. Typically, when the piston 14 is located near the top dead center or the bottom dead center, the velocity of the piston 14 is low, and the power generation efficiency or the propulsion efficiency of excitation current in those regions is lower than in other regions. Therefore, as indicated by, for example, hatching in FIG. 3, power generation and supply timing may be controlled to suspend electric braking and supply of excitation current (to allow the piston 14 to move freely) while the piston 14 is being located at the top dead center or the bottom dead center, and to generate and supply power in the remaining regions. The bottom portion of FIG. 3 illustrates power variations. The amount of power generation during firing (during power generation) is denoted by solid lines, and the amount of power supply during motoring is denoted by broken lines.

Power generation and supply regions (and therefore power generation and supply suspension regions) may be freely determined. For example, a region extending from a half value representing a midpoint between a top dead center target position and a point of origin to a half value representing a midpoint between a bottom dead center target position and the point of origin may be set as a coil excitation region and a power generation region. Alternatively, a region of within 90% of the maximum velocity of the piston 14 may be set as an excitation region and a power generation region.

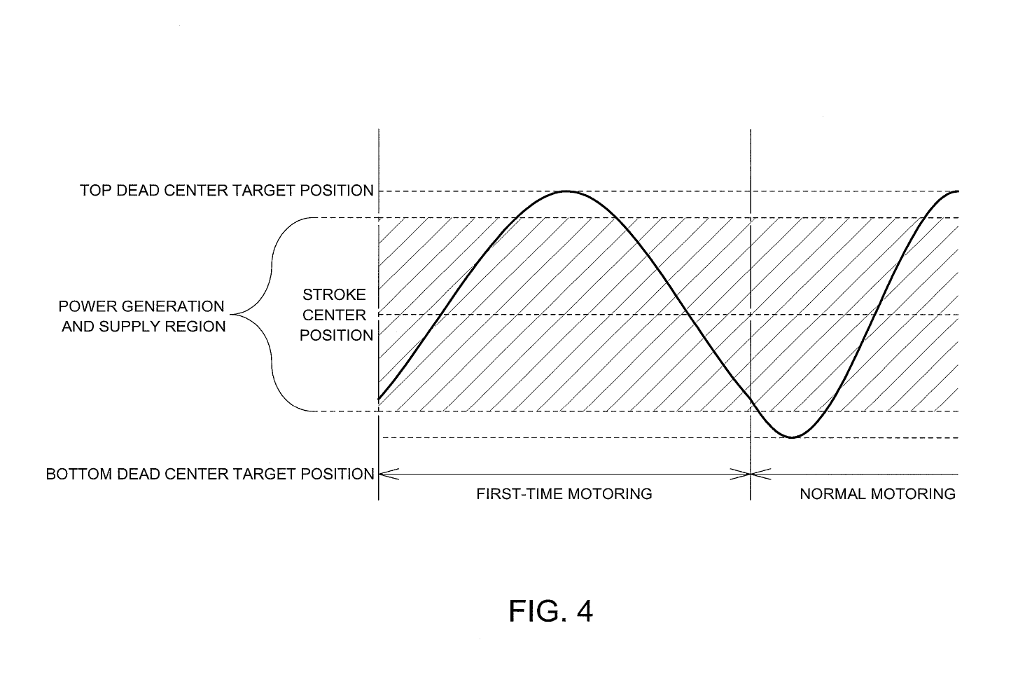

However, at a start of motoring, when, as described above, power supply (excitation) is suspended near the top dead center or near the bottom dead center, the piston 14 stops at a position that is off the center toward the top dead center or the bottom dead center, and an attempt to move the piston 14 toward the top dead center or toward the bottom dead center by motoring will result in suspension of power supply in a short period of time and insufficient urging of the piston 14. To avoid this situation, in preferred embodiments, as illustrated in FIG. 4, when the position at which the piston 14 stops is known, excitation current supplied to the coil 26 is controlled to urge the piston 14 toward the side opposite the stop position of the piston 14 with respect to the stroke center position. For example, when the stop position of the piston 14 is closer to the gas spring chamber 22 (the bottom dead center) with respect to the stroke center position, the controller 18 supplies excitation current to the coil 26 to move the piston 14 toward the combustion chamber 20 (the top dead center).

Alternatively, other startup methods may include a method in which the movable region of the piston 14 is restricted to the excitation region except near the top dead center and near the bottom dead center as described above. When this method is employed, in preferred embodiments, velocity control is performed to adjust the velocity of the piston 14 to prevent the piston 14 from reaching the top dead center or the bottom dead center. For example, amplitude proportional gain k_{pA}, amplitude integral gain k_{iA}, offset proportional gain k_{pO}, and offset integral gain k_{iO} for the velocity control, which will be described below, are set to somewhere near 1/10 of typical values.

### Generation of Velocity Command Wave

As described above, velocity control is performed to control the velocity of the piston 14 to a first velocity command value in the expansion stroke and to a second velocity command value in the compression stroke. Therefore, a velocity command wave corresponding to the stroke of the piston 14 takes the form of a rectangular (pulse) wave having the first velocity command value and the second velocity command value as peak values, as illustrated in FIG. 3. The generation of the velocity command wave will be described below. The controller 18 sets the first and second velocity command values by setting first and second velocity command values for a certain round-trip period based on a top dead center position and a bottom dead center position of the piston 14 for the previous round-trip period.

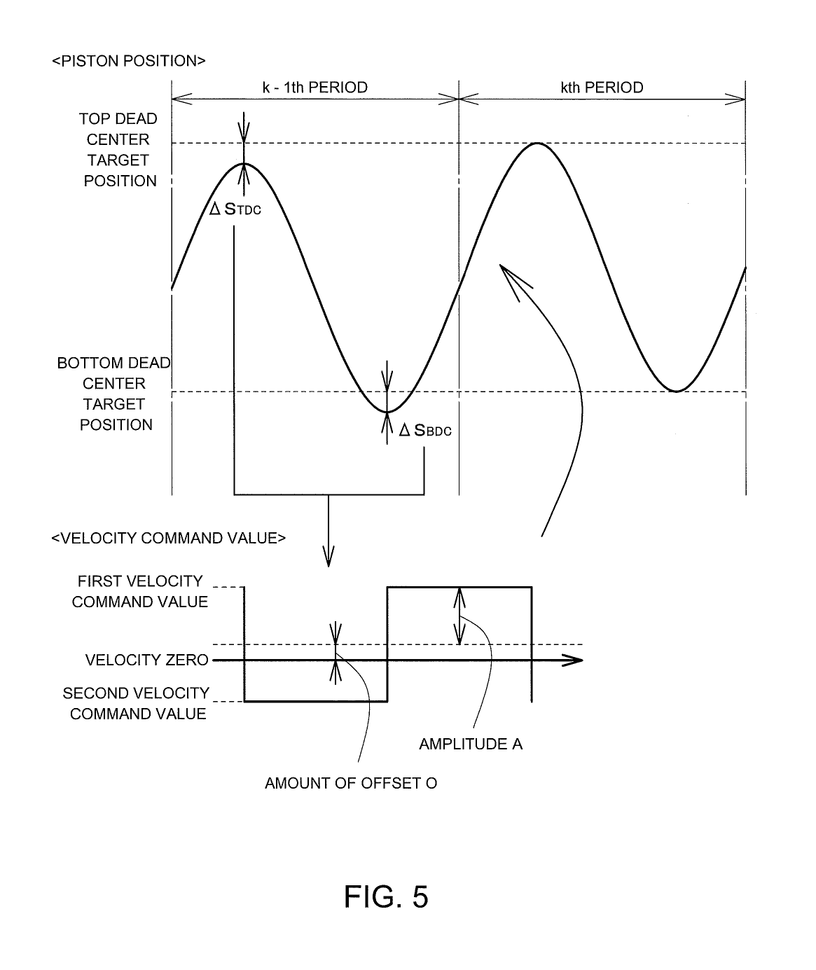

Specifically, as illustrated in FIG. 5, the controller 18 first determines a difference between a predetermined top dead center target position and an actual top dead center for the k-1th period and a difference between a predetermined bottom dead center target position and an actual bottom dead center for the k-1th period. After a difference ΔS_{TDC} between the top dead center target position and an actual top dead center and a difference ΔS_{BDC} between the bottom dead center target position and an actual bottom dead center are determined, the controller 18 uses these values to determine an amplitude A of the velocity command wave and an amount of offset O of the velocity command wave from a velocity of zero. The amplitude A of the velocity command wave may be determined using the following equation (1):

A=k_{pA}(ΔS_{TDC}−ΔS_{BDC})+k_{id}∫(ΔS_{TDC}−ΔS_{BDC}) (1)

The amount of offset O of the velocity command wave may be determined using the following equation (2):

O=k_{pO}(ΔS_{TDC}+ΔS_{BDC})+k_{iO}∫(ΔS_{TDC}+ΔS_{BDC}) (2)

A velocity command wave (including a first velocity command value and a second velocity command value) for the kth period is generated based on the amplitude A and the amount of offset O that are determined using equations (1) and (2).

In equation (1), k_{pA} represents amplitude proportional gain, and k_{iA} represents amplitude integral gain. In equation (2), k_{pO} represents offset proportional gain, and k_{iO} represents offset integral gain.

### Balance Adjustment of Velocity Command Value

When, as illustrated in FIG. 3, the amount of power generation (or the amount of power supply during motoring) is uneven in the expansion stroke and in the compression stroke, typically, the greater the amount of power generation, the lower the efficiency. Additionally, supply of power during power generation periods and, conversely, generation of power during motoring (power supply) periods due to power variations also cause a reduction in efficiency. To alleviate such lack of balance in amount of power (the amount of power generation or the amount of power supply) in the expansion stroke and in the compression stroke to level the amount of power in both strokes, in the illustrated embodiment, the bottom dead center target position is changed.

Lack of balance in amount of power in the expansion stroke and in the compression stroke is alleviated by simply adjusting the bottom dead center target position. Typically, the bottom dead center target position is adjustable in a certain range (on the other hand, the top dead center position is related to the ratio of compression for combustion control, and it is difficult to provide a range over which the top dead center target position is adjustable). Lowering the bottom dead center target position (moving the bottom dead center target position toward an end of the cylinder) causes the piston 14 to move over a longer distance in the expansion stroke, and therefore provides a smaller electric braking force during the expansion stroke (a larger driving force during motoring), and as a result, the amount of power generation decreases (the amount of power supply increases). On the other hand, because the piston 14 reaches a point closer to the bottom dead center, energy accumulated in the gas spring chamber 22 increases. As this energy is released in the compression stroke, dynamic braking force should be correspondingly increased. As a result, the amount of power generation in the compression stroke increases (the amount of power supply decreases). In other words, the amounts of power in the expansion stroke and in the compression stroke are balanced.

The bottom dead center target position is adjusted according to, for example, the following criteria. When a total amount of power generation during the control based on the first velocity command value is greater than a total amount of power generation during the control based on the second velocity command value, the bottom dead center target position is changed to move away from the stroke center position of the piston 14. When a total amount of power generation during the control based on the second velocity command value is greater than a total amount of power generation during the control based on the first velocity command value, the bottom dead center target position is changed to move toward the stroke center position of the piston 14. By changing the bottom dead center target position in this manner, a difference between an absolute value of the first velocity command value and an absolute value of the second velocity command value is reduced, and the amounts of power in the expansion stroke and in the compression stroke are balanced.

### Cooperative Control of Pressure in Gas Spring Chamber

In some embodiments, to achieve increased output, the amount of fuel injected into the combustion chamber 20 is increased. Then, as the combustion pressure increases, the piston 14 may collide against an end wall of the gas spring chamber 22. To avoid such collision, the gas pressure (spring modulus) in the gas spring chamber 22 may be increased in accordance with the increase in combustion pressure. For example, a pressurization source such as a compressor may be connected to the gas spring chamber 22. The controller 18 controls the pressurization source to increase the gas pressure in the gas spring chamber 22 so that it follows the increase in combustion pressure.

### Other Modifications

Although, in the above-described embodiments, the gas spring chamber 22 is provided opposite the combustion chamber 20, various modifications are possible. Any structure including a mechanism for producing a repulsive force that pushes back the piston 14 toward the combustion chamber 20 against the urging of the piston 14 may be employed. For example, any other spring element or elements may be provided instead of the gas spring chamber 22. Specifically, one or more elastic bodies may be provided on an inner wall of the cylinder 12 that is perpendicular to the stroke direction of the piston 14. Metal or resin shaped into a spring such as a coil spring or a disc spring may be used as an elastic body. Alternatively, elastic material such as rubber may be filled into a space corresponding to the gas spring chamber 22. Still alternatively, magnets may be provided instead of the gas spring chamber 22. For example, magnets may be provided on opposing surfaces of the piston 14 and the cylinder 12, and the repulsive force between those magnets may be used. The magnets may be permanent magnets or may be electromagnets. If it is difficult for the piston 14 to receive a supply of power, a permanent magnet or magnets are preferred for the piston 14. Additionally, it is also possible to combine the gas spring chamber 22 with at least one of the above-described elements such as springs, elastic material, and magnets. Further, the gas spring chamber 22 may be replaced by a second combustion chamber.

To adjust the spring modulus in accordance with the combustion pressure of the combustion chamber 20 as described above, if a spring or elastic material is employed, for example, a movement mechanism for changing the position of the spring or elastic material in the stroke direction of the piston 14 may be provided. If electromagnets are employed, the repulsive force may be adjusted by adjusting the amount of current. If the gas spring chamber 22 is replaced by a second combustion chamber, the repulsive force may be adjusted by adjusting the amount of fuel injected into the second combustion chamber in accordance with changes in the amount of fuel injected into the combustion chamber 20.

What is claimed is:

1. A controller for a free piston generator that generates power by causing a piston with a magnet embedded therein to reciprocate in a cylinder provided with a coil, the cylinder having a combustion chamber therein, the controller being configured to:
set a first velocity command value for an expansion stroke in which the piston is moved away from the combustion chamber and a second velocity command value for a compression stroke in which the piston is moved toward the combustion chamber; and
control an amount of power generation to cause a velocity of the piston to reach the first and second velocity command values by electric braking during power generation, or control an amount of power supply to cause the velocity of the piston to reach the first and second velocity command values by exciting the coil during motoring,
wherein setting the first and second velocity command values comprises setting first and second velocity command values for a certain round-trip period based on a top dead center position, at which the piston is located closest to the combustion chamber, and a bottom dead center position, at which the piston is located most far away from the combustion chamber, for the previous round-trip period.

2. The controller for the free piston generator according to claim 1, wherein the cylinder further has a gas spring chamber therein, and the piston reciprocates between the combustion chamber and the gas spring chamber.

3. The controller for the free piston generator according to claim 2, wherein the controller is further configured to determine an amplitude of a velocity command wave having the first velocity command value and the second velocity command value as peak values and an amount of offset of the velocity command wave from a velocity of zero for a certain round-trip period based on a difference between an actual top dead center position and a top dead center target position and a difference between an actual bottom dead center position and a bottom dead center target position for the previous round-trip period.

4. The controller for the free piston generator according to claim 3, wherein the controller is further configured to reduce a difference between an absolute value of the first velocity command value and an absolute value of the second velocity command value by changing the bottom dead center target position.

5. The controller for the free piston generator according to claim 2, wherein the controller is further configured to:
when a total amount of power generation during control based on the first velocity command value is greater than a total amount of power generation during control based on the second velocity command value, change a bottom dead center target position of the piston to move away from a stroke center position of the piston; and
when a total amount of power generation during control based on the second velocity command value is greater than a total amount of power generation during control based on the first velocity command value, change the bottom dead center target position of the piston to move toward the stroke center position of the piston.

6. The controller for the free piston generator according to claim 2, wherein the controller is further configured to increase a gas pressure in the gas spring chamber in accordance with an increase in combustion pressure in the combustion chamber.

7. The controller for the free piston generator according to claim 2, wherein the controller is further configured to, at a start of motoring, control excitation current supplied to the coil to urge the piston toward a side opposite a stop position of the piston with respect to a stroke center position.

8. The controller for the free piston generator according to claim 2, wherein the controller is further configured to control power generation and supply timing to suspend power generation and supply while the piston is being located at the top dead center position or the bottom dead center position.

9. The controller for the free piston generator according to claim 8, wherein the controller is further configured to, during the motoring, set a region extending from a half value representing a midpoint between a top dead center target position and a point of origin to a half value representing a midpoint between a bottom dead center target position and the point of origin as an excitation region for the coil.

10. A controller for a free piston generator that generates power by causing a piston with a magnet embedded therein to reciprocate between a combustion chamber and a gas spring chamber in a cylinder provided with a coil, the controller being configured to:
set a first velocity command value for an expansion stroke in which the piston is moved toward the gas spring chamber and a second velocity command value for a compression stroke in which the piston is moved toward the combustion chamber;
control an amount of power generation to cause a velocity of the piston to reach the first and second velocity command values by electric braking during power generation, or control an amount of power supply to cause the velocity of the piston to reach the first and second velocity command values by exciting the coil during motoring; and
control power generation and supply timing to suspend power generation and supply while the piston is being located at a top dead center position, at which the piston is located closest to the combustion chamber, or at a bottom dead center position, at which the piston is located closest to the gas spring chamber.
